(19) United States
(12) Patent Application Publication
(10) Pub. No.: US 2010/0213023 A1
(43) Pub. Date: Aug. 26, 2010

(54) VOUCHER MACHINE

(75) Inventors: Paul Freitag, Steinheim (DE); Udo Petermann, Altenbeken (DE)

Correspondence Address: HARNESS, DICKEY & PIERCE, P.L.C., P.O. BOX 828, BLOOMFIELD HILLS, MI, 48303, US

(73) Assignee: WINCOR NIXDORF INTERNATIONAL GMBH, Paderborn (DE)

(21) Appl. No.: 12/599,596

(22) PCT Filed: Jun. 6, 2008
(86) PCT No.: PCT/EP2008/004512

§ 371 Date: Nov. 10, 2009

(30) Foreign Application Priority Data
Jun. 22, 2007 (DE) 10 2007 028 858.3

(51) Int. Cl. G07F 7/04; G07F 9/10

(52) U.S. Cl. 194/206

(57) ABSTRACT

A voucher machine, particularly an automated teller machine, for the input and output of vouchers such as cash or checks, having a processing section (1) for transporting and processing vouchers to be input and output, is characterized in that the processing section (1) has two processing circuits (5, 6) for processing input vouchers which allows rapid output of vouchers identified as unsuitable for acceptance.

The invention relates to a voucher machine for the input and output of vouchers, such as cash or checks, in accordance with the preamble of claim 1.

Voucher machines configured as self-service devices—refer to US 2007/0034863 A1, for example—for the input and output of vouchers such as bank notes or checks usually have a deposit drawer to input the vouchers to which a circulatory processing section is attached downstream. In addition to transport rollers and/or belts, this processing section usually comprises several stations, such as a sensor system to identify folded or damaged bank notes, or those with foreign objects attached, a station to verify authenticity, one or more roller storage systems for temporary storage of vouchers, a valuables cassette to store vouchers and an output drawer for vouchers to be output, including vouchers that were not accepted at the time they were input.

This structure has proved itself in its essentials, but in operation it often leads to relatively long transaction times.

The object of the invention is to solve this problem.

The invention achieves this object with the subject of claim 1.

Since, in addition to the longer processing circuit, the processing section includes a shorter processing circuit for the direct re-output of vouchers identified by the sensor system as unsuitable for acceptance, unsuitable bills can be re-output directly after they have been identified so that the transaction in such cases can be shortened. Moreover, this reduces the risk that the vouchers identified as unsuitable—for example, if they have metal items such as staples adhering to them—may cause operating malfunctions in the longer processing circuit.

Advantageous embodiments can be found in the dependent claims.

The invention is described hereinafter in greater detail using embodiments with reference to the drawing.

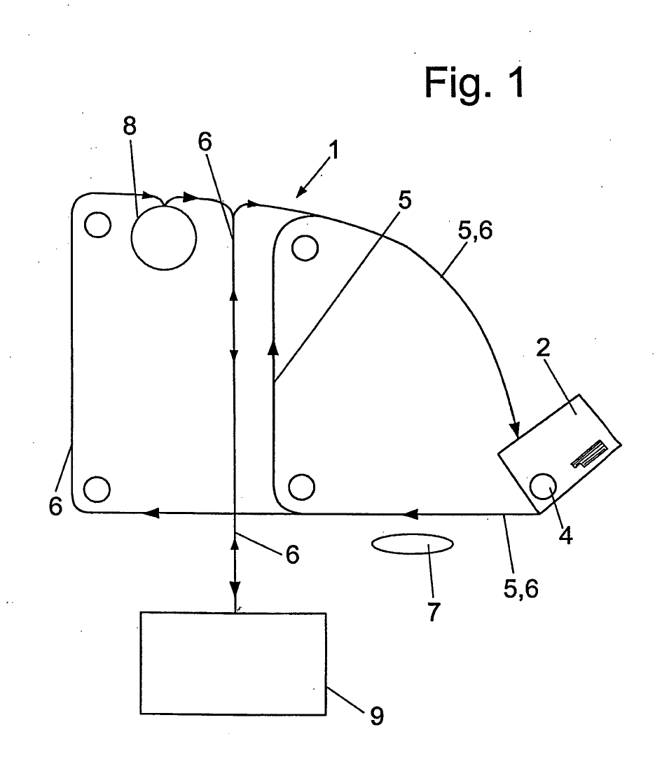

FIG. 1 shows a schematic representation of a processing circuit for vouchers in a voucher machine;

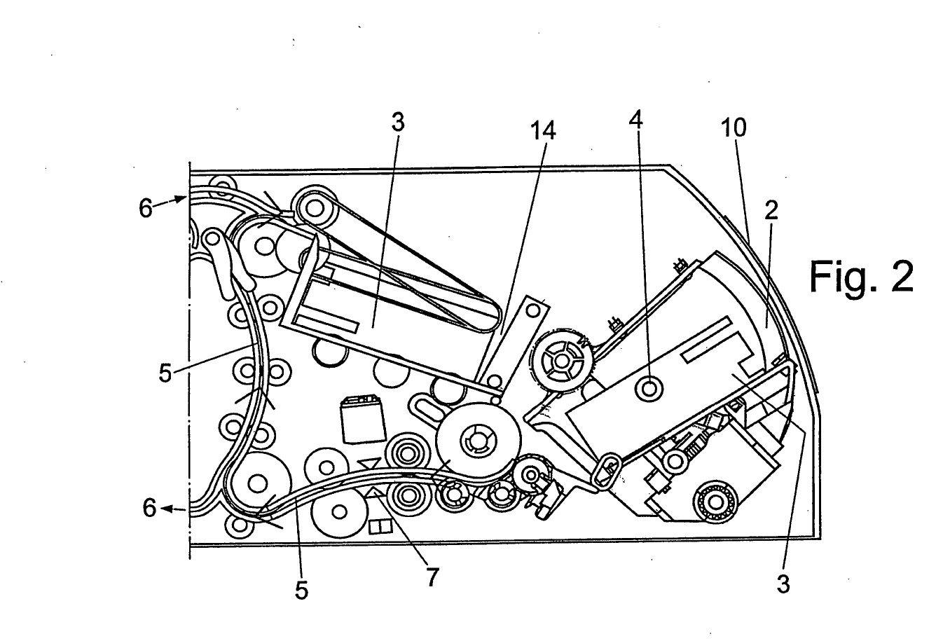

FIGS. 2-4 show a partial area of a processing section for vouchers in a voucher machine in different operating positions.

FIG. 1 shows a schematic representation of a processing section 1 for vouchers in a voucher machine not otherwise shown. The voucher machine has a combination input and output drawer 2 for the input and output of vouchers that are collected into a bundle or stack 3 in the representations of FIGS. 2 to 4. The input and output drawer 2 is designed for the input of one or more vouchers. It is preferably designed in such a way that up to 200 vouchers can be processed in a single transaction.

The input and output drawer 2 is carried pivotably on an axis of rotation 4 so that it can pivoted through an angle, here for example of about 100°, into the operating positions in FIGS. 2 to 4.

The input and output drawer 2 is the start and endpoint respectively of the processing section 1 to transport and process vouchers to be input and output.

In accordance with FIG. 1, this processing section 1 has a first—shorter—processing circuit 5 and a second—longer—processing section 6, wherein the processing circuits 5, 6 overlap in sections—in this case at the beginning and at the end.

The shorter processing circuit 5 serves to re-output as directly as possible vouchers identified at a sensor system 7 as unsuitable, meaning, for example, that they are damaged, crumpled or contain a foreign body, bypassing additional stations such as roller storage systems and a valuables cassette where applicable.

Vouchers can be output in the combination input and output drawer 2 provided here or in a separate output drawer (not shown here), wherein preference is given to the first variant because of its simpler construction.

Input vouchers that have not been rejected by the sensor system and taken to the output undergo further processing in the longer processing circuit 6. Stations for additional processing may include an authenticity check and temporary storage in one or more voucher storage systems, for example, on roller storage systems 8 and storage in a valuables cassette 9.

The longer processing circuit 6 additionally serves to output vouchers when the voucher machine is used as an automated teller machine, for example, or if an additional deposit is cancelled by the user after it has passed the sensor system 7.

Since the shorter processing circuit 5 is configured very much shorter than the longer processing circuit 6, transaction time is considerably shortened in all cases in which the sensor system 7 identifies vouchers that are damaged, folded or contain foreign bodies, which has an advantageous effect on the operating efficiency of the voucher machine.

The input/output drawer 2 forms a manual interface between an operator and the system, or the processing sections respectively. Other components of the voucher machine, such as a display or a keypad and the housing are not shown in FIGS. 1 to 4, or only sections thereof.

After a shutter 10 has been opened, a maximum of 200 vouchers, with the long side to the front, can be placed in the input/output drawer 3 by the operator. The entire bundle is rejected if the thickness of the bundle exceeds 90 mm.

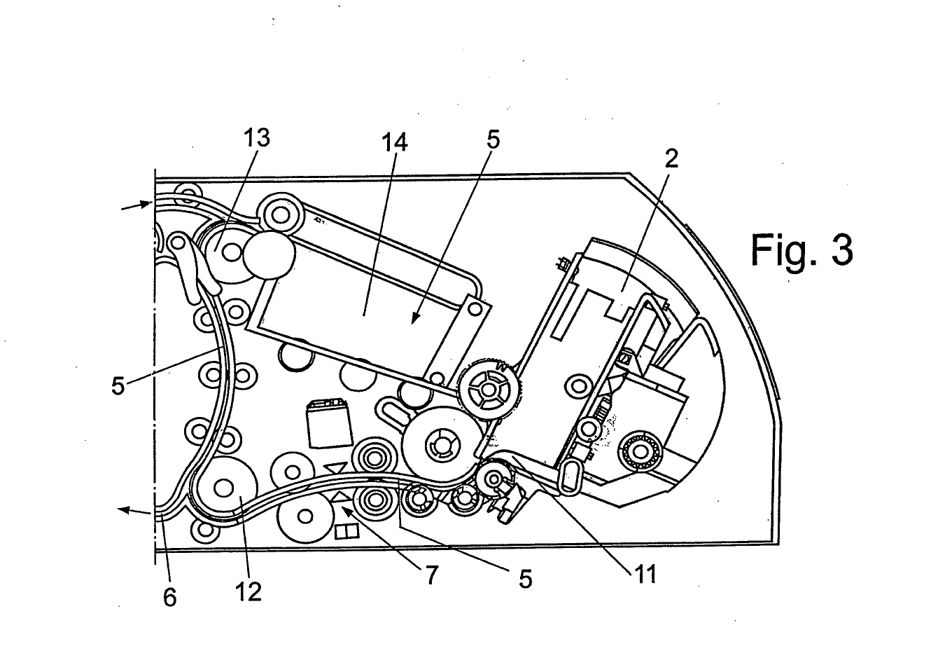

After the bundle has been inserted correctly (FIG. 2), the shutter 10 closes and the input and output drawer 2 pivots into a position for individual separation (FIG. 3). Individual separation of the input vouchers 2 is carried out, for example, at a separating station 11 operating on the principle of draw-off shaft, drive roller shaft, countershaft and retaining comb.

After they have been individually separated, the vouchers are inspected at the sensor system 7 for foreign bodies. Multiple draw-offs, the size of the vouchers and the position of the vouchers are preferably identified and evaluated by the sensor system 7, which can comprise several sensors. Vouchers identified as unsuitable for the machine (e.g. vouchers folded once lengthwise or crosswise, vouchers with staples, etc.) are then diverted over the “short” processing circuit 5 by means of jockey rollers 12, 13 directly into a collecting drawer 14. A maximum of 200 notes can be stacked in the collecting drawer 14. The sensor system 7 preferably also identifies individual notes folded once crosswise or lengthwise.

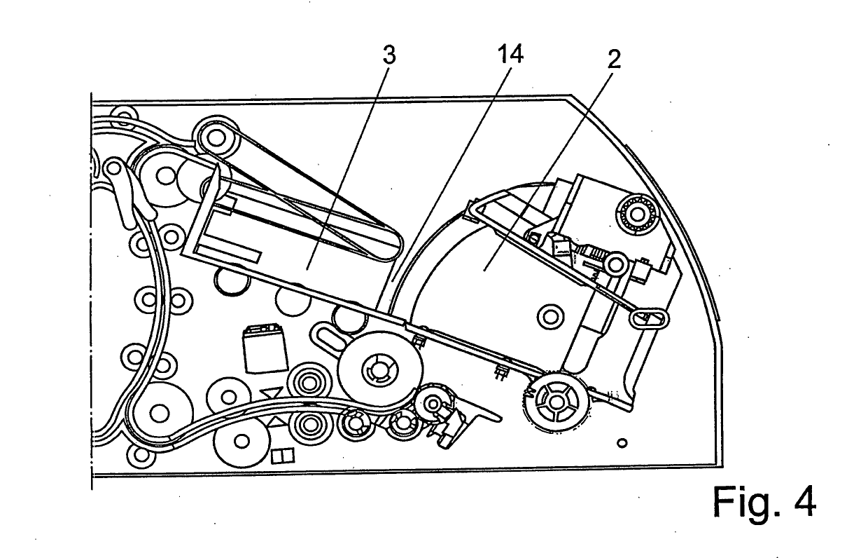

The collected notes are then transported back from the collecting drawer 14 to the empty input and output drawer 2, now pivoted into the position in FIG. 4. After the input and output drawer 2 has been suitably rotated back into the position in FIG. 2, the stack 3 can either be sorted individually again or it is proffered to the operator for removal.

If the notes jam, the remaining notes first have to be removed from the input and output drawer 2, then, any notes are transported from the collecting drawer 14 into the input and output drawer 3 from which they can be removed after the shutter 10 is opened.

If, on the other hand, the vouchers are identified at the sensor system 7 as suitable for further processing, they are taken past the jockey roller 12 into the longer processing circuit 6 that is only indicated roughly in FIG. 2 and that comprises a station for the authenticity check and at least one voucher storage system 8, 9. For disbursal, vouchers are taken from these voucher storage systems 8, 9 again, first into the collecting drawer 14 before they are output into the input and output drawer 3 in the manner of FIG. 3.

### REFERENCE NUMERALS

Processing section 1
Input and output drawer 2
Bundle 3
Axis of rotation 4
Processing circuit 5
Processing circuit 6
Sensor system 7
Roller storage system 8
Valuables cassette 9
Shutter 10
Individual separation station 11
Jockey rollers 12, 13
Collection drawer 14

1. A voucher machine for the input and output of vouchers such as cash or checks, said voucher machine comprising a processing section for processing and for transporting vouchers to be input and output, wherein the processing section has two processing circuits for processing input vouchers.

2. The voucher machine from claim 1, wherein the process circuits overlap in sections.

3. The voucher machine from claim 1, wherein the one of the processing circuits is shorter than the other, longer processing circuit.

4. The voucher machine from claim 1, wherein the voucher machine has an input drawer and an output drawer for the input or output of vouchers respectively.

5. The voucher machine from claim 1, wherein the voucher machine has a combination input and output drawer for the input and output of vouchers.

6. The voucher machine from claim 1, wherein the combination input and output drawer is designed to be pivotable.

7. The voucher machine from claim 1, wherein the shorter processing circuit comprises a sensor system to identify vouchers unsuitable for acceptance, said system being designed particularly to identify folded or damaged vouchers or those with foreign bodies attached.

8. The voucher machine from claim 1, wherein the shorter processing circuit is designed to divert and output vouchers identified at the sensor system as unsuitable directly into a collecting drawer and/or an output drawer.

9. The voucher machine from claim 1, wherein the longer processing circuit comprises at least one voucher storage system such as one or more roller storage systems and/or the collecting drawer for storing vouchers.

10. The voucher machine from claim 1, wherein the collecting drawer is located upstream from the input and output drawer.

11. The voucher machine from claim 1, being designed as part of an automated teller machine.
